(19) United States
(12) Patent Application Publication
(10) Pub. No.: US 2024/0196981 A1
(43) Pub. Date: Jun. 20, 2024

(54) AEROSOL PROVISION SYSTEM WITH POWER-SAVING MODE

(71) Applicant: Nicoventures Trading Limited, LONDON (GB)

(72) Inventors: Robert KERSEY, Brighton (GB); Darryl BAKER, LONDON (GB); Nejat ERGUVEN, LONDON (GB)

(21) Appl. No.: 18/554,528

(22) PCT Filed: Apr. 8, 2022
(86) PCT No.: PCT/GB2022/050891

§ 371 Date: Oct. 9, 2023

(30) Foreign Application Priority Data
Apr. 9, 2021 (GB) 2105120.6

(51) Int. Cl. A24F 40/50; A24F 40/60; A24F 40/65

(52) U.S. Cl. CPC A24F 40/50; A24F 40/60; A24F 40/65

(57) ABSTRACT

There is provided a non-combustible aerosol provision system that includes an aerosol generator to generate aerosols, a power source to supply power to the aerosol generator, and a transmitter/receiver element configured to communicably couple the non-combustible aerosol provision system to a user device. The non-combustible aerosol provision system is operable in a standard mode and a power-saving mode. When the non-combustible aerosol provision system is in the power-saving mode, the power source is configured to supply less power to one or more power-consuming components of the non-combustible aerosol provision system than when the non-combustible aerosol provision system is in the standard mode. The transmitter/receiver element is configured to receive an instruction from the user device, the instruction configured to cause the non-combustible aerosol provision system to enter the low power mode.

### PRIORITY CLAIM

The present application is a National Phase entry of PCT Application No. PCT/GB2022/050891, filed Apr. 8, 2022, which claims priority from GB Application No. 2105120.6, filed Apr. 9, 2021, each of which hereby fully incorporated herein by reference.

### TECHNICAL FIELD

The present disclosure relates to the field of power control. In particular, but not exclusively, the present disclosure relates to power control for an aerosol provision system.

### BACKGROUND

A “non-combustible” aerosol provision system is an aerosol provision system where a constituent aerosol-generating material of the aerosol provision system (or component thereof) is not combusted or burned in order to facilitate delivery of at least one substance to a user.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energized so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Known approaches are described in WO2015/155612A2, WO2020/260885A1, WO2012/109371A2, US2017/049151A1 and WO2014/163664A1.

### SUMMARY

Viewed from a first aspect, there can be provided a non-combustible aerosol provision system comprising: an aerosol generator to generate aerosols; a power source to supply power to the aerosol generator; a transmitter/receiver element configured to communicably couple the non-combustible aerosol provision system to a user device; wherein the non-combustible aerosol provision system is operable in a standard mode and a power-saving mode, wherein when the non-combustible aerosol provision system is in the power-saving mode, the power source is configured to supply less power to one or more power-consuming components of the non-combustible aerosol provision system than when the non-combustible aerosol provision system is in the standard mode; and wherein the transmitter/receiver element is configured to receive an instruction from the user device, the instruction configured to cause the non-combustible aerosol provision system to enter the low power mode. Thus the present approaches can provide for a non-combustible aerosol provision system to be controlled into a low power operation mode upon receipt of instruction from a user device.

Viewed from another aspect, there can be provided a user device configured to be communicably coupled to a non-combustible aerosol provision system, the user device comprising: a output device configured to provide user interface information to a user; an input device configured to receive an input from a user to activate a power saving mode of a communicably coupled non-combustible aerosol provision system; and a receiver transmitter element configured to send an instruction to adopt the power saving mode to the communicably coupled non-combustible aerosol provision system, the instruction to cause a power source of the non-combustible aerosol provision system to supply less power to one or more power-consuming components of the non-combustible aerosol provision system than when the non-combustible aerosol provision system is in a standard mode. Thus the present approaches can provide for a user device to be used for controlling a non-combustible aerosol provision system into a low power operation mode.

Viewed from a further aspect, there can be provided a system comprising: a non-combustible aerosol provision system; and a user device communicably coupled to the non-combustible aerosol provision system; wherein the non-combustible aerosol provision system is operable in a standard mode and a power-saving mode, wherein when the non-combustible aerosol provision system is in the power-saving mode, the power source is configured to supply less power to one or more power-consuming components of the non-combustible aerosol provision system than when the non-combustible aerosol provision system is in the standard mode; and wherein the user device is configured to send an instruction to adopt the power saving mode to the non-combustible aerosol provision system. Thus the present approaches can provide for user device to interact with a non-combustible aerosol provision system to control the non-combustible aerosol provision system into a low power operation mode upon receipt of instruction from the user device.

According to another aspect, there can be provided a computer-readable medium comprising instructions which, when executed by processing circuitry of a computing device configured to be communicably coupled to a non-combustible aerosol provision system, cause the computing device to: receive an input from a user to activate a power saving mode of a communicably coupled non-combustible aerosol provision system; and send an instruction to adopt the power saving mode to the communicably coupled non-combustible aerosol provision system, the instruction to cause a power source of the non-combustible aerosol provision system to supply less power to one or more power-consuming components of the non-combustible aerosol provision system than when the non-combustible aerosol provision system is in a standard mode. Thus the present approaches can provide for a user device to be programmed for controlling a non-combustible aerosol provision system into a low power operation mode.

### BRIEF DESCRIPTION OF FIGURES

Embodiments and examples of the present approaches will now be described, by way of example only, with reference to the accompanying drawings, in which:

FIG. 1 is a schematic illustrating an example of a non-combustible aerosol provision system.

FIG. 2 is a schematic illustrating an example of a user device.

FIG. 3 is a flowchart illustrating a method of selecting a low power mode setting for a non-combustible aerosol provision system.

FIG. 4 is a schematic illustrating a user interface for selecting a low power mode setting for a non-combustible aerosol provision system.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

Non-combustible aerosol provision systems typically comprise a heater to subject aerosol-generating material to heat energy, so as to release one or more volatiles from the aerosol-generating material to form an aerosol.

By varying the power applied to the heater of the non-combustible aerosol provision system, the properties of the aerosols generated by the non-combustible aerosol provision system can be controlled. For example, by providing more power to the heater, a larger volume of aerosol can be produced by the non-combustible aerosol provision system for a given aerosol generation activation than if lower power were supplied. The volume of aerosol created by an aerosol generation activation may be termed a cloud, and thus it may be termed that a changed heater power may lead to a changed size of the cloud.

In accordance with the techniques described herein, there is provided an approach by which a user can cause the non-combustible aerosol provision system to adopt a low power mode. In the low power mode the non-combustible aerosol provision system may be caused to generate aerosols at a low heater power and/or a shortened generation duration. Other functionalities of the non-combustible aerosol provision system may also or alternatively be caused to adopt a low power consumption behavior. Thus the user can take positive action to provide a lengthened lifetime of a power source and/or aerosolizable material reserve of the non-combustible aerosol provision system.

By providing a mechanism to control the power level setting of the non-combustible aerosol provision system in this way, the present techniques provide a high level of control over the conservation of depletable resources of the non-combustible aerosol provision system. This can be useful for example, to compensate for perceived or potential shortages of such depletable resources between the activation of the low power mode and a time at which those resources may be replenished. For example, since the rate at a power supply of the non-combustible aerosol provision system (e.g., a battery) and a supply of aerosolizable material is depleted may be linked to the power supplied to the heater, controlling the heater power setting can also be used to affect (e.g., slow down) the rate at which the battery/supply of material is used up.

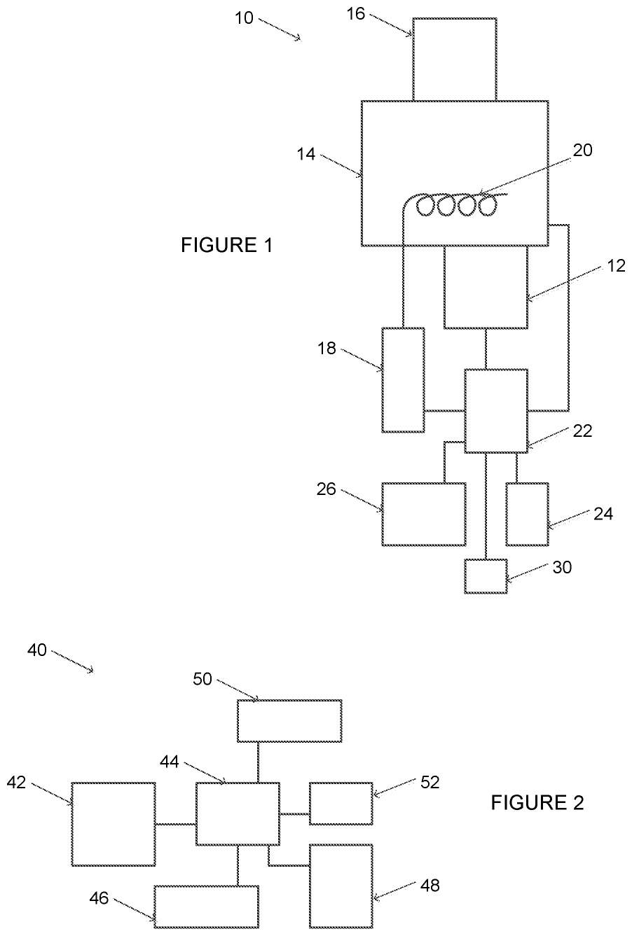

It will be appreciated that the present approaches involve transmission of data to and from a non-combustible aerosol provision system, and for the non-combustible aerosol provision system to process stored and/or received data. Also, the present approaches require a user device to be capable of communicating with a non-combustible aerosol provision system. Such a user device may be capable of communicating with other services or systems. Therefore, to illustrate suitable devices for providing such functionalities, an example non-combustible aerosol provision system 10 and an example user device 40 are illustrated with respect to FIGS. 1 and 2 respectively.

An example of a non-combustible aerosol provision system 10 is schematically illustrated in FIG. 1. As shown, the aerosol delivery device 10 is a device which contains elements relating to aerosol generation such as an aerosol medium container or cartridge 12 (in the case of an END device, the aerosol medium container or cartridge 12 will contain nicotine or a nicotine-bearing formulation), an aerosol generation chamber 14 and an outlet 16 through which a generated aerosol may be discharged. A battery 18 may be provided to power a thermal generator element (such as a heater 20 which may take the form of a heater coil) within (or functionally adjacent to) the aerosol generation chamber 14. The battery 18 may also power a processor/controller 22 which may serve purposes of device usage, such as activation of the device for aerosol generation in response to an activation trigger, and purposes of communication and functionality control. Processor/controller 22 may have access to a memory 24 which may be used to store operating instructions for the processor/controller 22. The memory 24 may also be used to store data describing operating conditions and/or states of the non-combustible aerosol provision system 10 and/or one or more components thereof. The memory 24 may be internal to the processor/controller 22 or may be provided as an additional separate physical element.

To perform transmission and reception of data and/or messaging, the processor/controller 22 is provided with a transmitter/receiver element 26. The transmitter/receiver element 26 enables the non-combustible aerosol provision system 10 to communicate with a connected device using a connectivity technology such as a personal area network protocol. Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA), and data-over-sound. Other wireless technologies such as a Wi-Fi™ technology may be used if the non-combustible aerosol provision system has suitable capability. In other examples, the transmitter/receiver element 26 may be configured to provide for a wired communication channel provided between physical ports of the non-combustible aerosol provision system 10 and a connected device. Such a wired communication channel may utilize a physical connection technology such as USB™, a serial port, FireWire™ or other point-to-point wired connectivity. The remainder of this discussion will use the example of BLE and will use BLE terminology, although it will be appreciated that corresponding or equivalent functionalities of other personal area network technologies may be substituted. Thus, in the present example, the transmitter/receiver element 26 is a BLE interface element including or connected to a radio antenna for wireless communication. In other examples such as those indicated above this may be an interface element for an alternative wireless technology and/or a wired connection interface.

Any communication established with a connected device may be impermanent or otherwise transient in the sense that the channel may be established for a period of time necessary to carry out specific functionalities, but may also be disconnected when not required. For this reason such a connected device will be referred to herein as a user device, in the sense that the device is likely to be utilized and/or controlled by a user of the non-combustible aerosol provision system 10 and a connected device. An example of such a user device (which may also be termed a remote device, in the sense that the device is remote from the non-combustible aerosol provision system, or intermediary device, in the sense that the device is intermediate between the non-combustible aerosol provision system and the unlock/age verification services) is described below with reference to FIG. 2.

Returning to the discussion of FIG. 1, the processor/controller 22 may in one example be an STM32 microcontroller as provided by ST Microelectronics and based on the ARM™ Cortex™-M processor. In other examples an alternative microcontroller or processor may be used, which may be based upon an ARM™ architecture, and Atom™ architecture or other low power processor technology. Alternatively or additionally, the transmitter/receiver element 26 may in one example include an nRF BLE chip for cooperating with the processor/controller to provide BLE connectivity to the non-combustible aerosol provision system. In other examples, other communication interface chips or modules may be deployed to provide connectivity services.

As illustrated, processor/controller 22 may be connected for example to aerosol medium container or cartridge 12, aerosol generation chamber 14 and battery 18. This connection may be to an interface connection or output from ones of the components and/or may be to a sensor located at or in ones of the components. These connections may provide access by the processor to properties of the respective components. For example a battery connection may be used to control activation of the non-combustible aerosol provision system for aerosol generation.

In some examples, the processor/controller 22 may be configured to control a voltage level provided from the battery to the heater 20, thereby to control the consumption of power from the batter and/or thereby to control the amount of aerosol produced by the non-combustible aerosol provision system 10 during a given aerosol production activation. The processor/controller 22 may additionally or alternatively be configured to control the duration that a voltage is provided from the battery to the heater 20 during a given aerosol production activation, thereby to control the consumption of power from the batter and/or thereby to control the amount of aerosol produced by the non-combustible aerosol provision system 10 during the aerosol production activation.

The non-combustible aerosol provision system 10 may also comprise an output element 30 (which may include one or more of a display, an audio output, and a haptic output). In some examples, the output element 28 may include one or more lights that can be selectively controlled to indicate a status, mode or other information about the operation of the non-combustible aerosol provision system 10. In some examples, the one or more lights are provided by one or more LEDs, which may be single color or multi-color LEDs.

In some examples, the processor/controller 22 may be configured to control a voltage provided from the battery to the output element 28. Thus a level of illumination of a light emitting output element (such as a display or light), and/or the level of output of an audio output element, and/or the level of vibration/movement of a haptic output element, may be controlled such as to provide for high level outputs and control outputs. Thus battery power may be conserved by controlling to a low output level.

In some examples, the processor/controller 22 may be configured to control a voltage provided from the battery to the processor/controller 22. Thus the processor/controller may be switchable between different power consumption modes, each corresponding to a different computation speed, different set of available processor/controller features, and/or different executable instructions. Thus in some examples the processor/controller 22 may be controllable into a low power mode in which only aerosol generation functionalities (and optionally lock/unlock functionalities) are available.

More generally, it is seen from the above that a variety of the components of the non-combustible aerosol provision system 10 require power from the battery (power source) in order to operate. At least some such power-consuming components may be caused to operate in a low power mode either by controlling delivery of electrical power to the component or by instructing the component to adopt a low power state.

Further functionalities of the non-combustible aerosol provision system in relation to adopting low power and/or power saving modes/states will be described with reference to the examples of the present approaches below.

An example of a user device 40 is schematically illustrated in FIG. 2. The user device may be a device such as a mobile telephone (cellphone) or tablet of a user (and/or owner) of the non-combustible aerosol provision system 10. As shown, the user device 40 includes a receiver transmitter element 42 for communicating with a non-combustible aerosol provision system 10. Thus the receiver transmitter element 42 will be configured to use the same connectivity and protocols, etc., as the non-combustible aerosol provision system 10 with which it is to interact in any given implementation. Accordingly, in the present examples, the receiver transmitter element 42 is a BLE interface element including or connected to a radio antenna for wireless communication. In other examples such as those indicated above this may be an interface element for an alternative wireless technology and/or a wired connection interface.

The receiver transmitter element 42 is connected to a processor or controller 44 which can receive and process the data or messaging received from the non-combustible aerosol provision system. The processor or controller 44 has access to a memory 46 which can be used to store program information and/or data. The user device 40 may include a further data transmission interface 48. This interface may provide one or more interface functionalities, for example to a wired connection such as wired local area network and/or to a wireless connection such as wireless local area network and/or cellular data services. This interface may be used for example for sending and receipt of messaging to and from various other devices, computer systems, and/or computer services as required by any particular implementation. This interface may also or alternatively be used for communications relating to other functionalities of the user device 40 which are unrelated to operation of or interaction with a non-combustible aerosol provision system.

The user device 40 also includes user interface elements including an output device 50 (which may include one or more of a display, an audio output, and a haptic output) and an input device 52 (which may include one or more of buttons, keys, touch-sensitive display elements, or a mouse/trackpad).

The user device 40 may be pre-programmed or configured to provide the functionalities according to the approaches discussed below. Additionally or alternatively, the user device may store software (e.g. in memory 46) such as an app to cause the processor or controller 44 to have those functionalities when the software is executed. Thus the user device may be a multi-purpose device that has the described functionalities when the app is executed.

Software to cause the user device to become programmed for the techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media such as carrier signals and transmission media. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. The term “computer-readable storage media” refers to physical storage media. Transient communication media may occur between components of a single computing system (e.g. on an internal link or bus between e.g. a memory and processor) or between separate computing systems (e.g. over a network or other inter-computing device connection), and may include transmission signals, carrier waves or the like.

Such software may be loaded directly to the user device 40 from a computer-readable medium, or may be loaded to the user device by connecting the user device to another computing device (such as a desktop computer, laptop computer or the like) and using software on the other computing device to control the loading of software to the user device.

Thus there have been described a non-combustible aerosol provision system and a user device that may interact to provide a number of additional functionalities for the non-combustible aerosol provision system to a user of the user device. Examples of such functionalities will now be described.

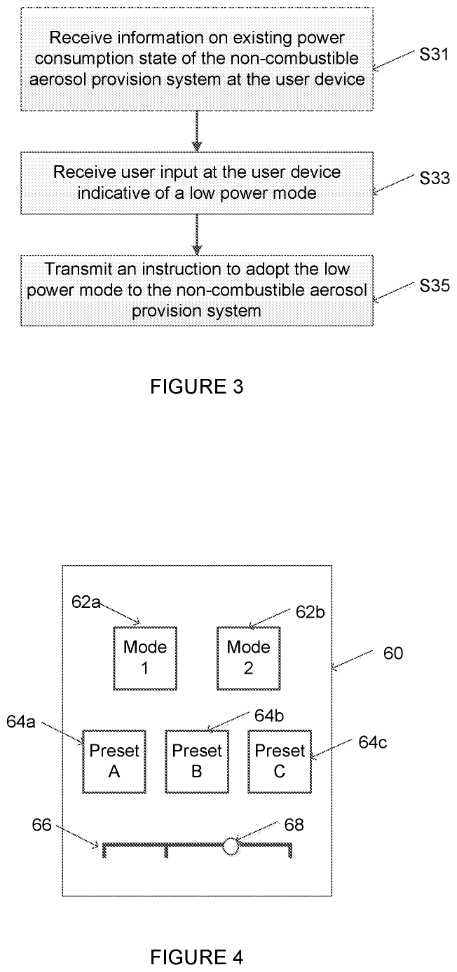

FIG. 3 is a flowchart illustrating a method of selecting a low power mode setting for the non-combustible aerosol provision system 10. Shown within dotted lines is an operation that is carried out in the present example but that may not be performed in all examples of the approach.

As shown in FIG. 3, at S31 the user device 40 receives information as to the existing power consumption state of the non-combustible aerosol provision system 10. In the present example, this is received from the non-combustible aerosol provision system 10, but in other examples the user may indicate the mode or the user device may have a stored value indicating the current mode.

In this example, the non-combustible aerosol provision system 10 is operable in a plurality of power consumption modes corresponding to different profiles of power consumption. In the present example these different power consumption modes affect the heater power settings that can be selected. Possible power consumption states include a power saving mode in which the available heater power settings that can be selected by a user are restricted to “low” heater power settings. That is, when operating the power saving mode, the non-combustible aerosol provision system 10 is configured to restrict access to heater power settings that would be otherwise be available when a power consumption state other than the power saving mode. In this way, the non-combustible aerosol provision system 10 is able to ensure that the heater power setting for the device will not be set above a certain value. Thus, the power delivered to the heater can be constrained, thereby saving power and prolonging the battery life of the device. Additionally, restricting the heater power in this way may also slow the depletion of a supply of aerosolizable material in the non-combustible aerosol provision system 10 thereby allowing the supply to last longer.

In some examples, the power saving mode may also or alternatively restrict the operational power delivery to other components of the non-combustible aerosol provision system 10, such as any output element 30 and/or the processor/controller 22.

Another example of a power consumption mode that may be implemented by the non-combustible aerosol provision system 10 in combination with the user device 40 is a standard mode. When operating in the standard mode, higher heater power settings may be accessible to give the user the greatest control over the heater power and consequently the properties of the aerosols generated.

Next, at S33 the user device 40 receives an input indicative of activating the power saving mode at the non-combustible aerosol provision system 10. In the present example this user input is received via the input element 52.

In the present examples, a user can choose to cause the non-combustible aerosol provision system 10 to enter a particular power consumption mode by providing a suitable controlling input at the user device 40. In the present example, the user device receives the user input at the input element 52 (which may include or more of buttons, keys, touch-sensitive display elements, or a mouse/trackpad as described above) of the user device 40. An example user interface screen which may be presented to a user on the output device 50 of the user device 40 for facilitating such input is illustrated with reference to FIG. 4 below. The user may spontaneously activate the power saving mode whenever desired, and/or may use information relating to remaining power and/or aerosolizable material resource of the non-combustible aerosol provision system 10 to decide when to activate the power saving mode.

The user input could take a number of possible forms. In the present example, the user selects an input option corresponding to the activation of the power saving mode. In other examples, the user input may comprise a value corresponding to the heater power setting. In such a case, the user device 40 may provide an input field in which a user can type a desired value (e.g., a number of watts of power or a percentage of a maximum power) for the heater power setting, where that value or percentage corresponds to a minimum or close-to minimum operating power of the heater. Additionally, or alternatively, the user input may comprise a selection of a position on a slider, with the position corresponding to the value of the heater power setting, where that position or percentage corresponds to a minimum or close-to minimum operating power of the heater. By allowing the user to directly select the value for the power to be applied, the user is given a high level of control over the operation of the device which may make adjustment of the device to achieve desired properties for the generated aerosols easier. For example, in some implementations the power saving mode may cause the heater power to be limited to the very lowest possible operation power setting, or alternatively may permit a selection of heater power in a low range (for example a contiguous range of possible values that includes the very lowest possible operational power setting and extends for e.g. 10% or 20% of the total possible power values range. Additionally, the user device 40 may restrict the user's selection to values (where a range is available) that vary by a fixed increment for example. In one example, the user device 40 restricts the user's selection in standard mode to values corresponding to a heater power between 2.0 W and 6.5 W in increments of 0.1 W, and then further restricts the user's selection in power saving mode to either 2.0 W (being the lowest possible setting) or to a range that starts at 2 W and extends up to e.g. 3.5 W.

Furthermore, in some examples, the user input options comprise selection of heater power setting from a plurality of preset heater power settings. The preset power settings may be preset by the user themself and stored on the user device 40 or may be common preset settings set for example by the manufacturer of the non-combustible aerosol provision system 10. This approach provides for more coarse-grained adjustment of the heater power settings and may simplify the selection of a heater power setting by the user. In the present example, when the power saving mode is active, the presets become unavailable for selection. In other examples, when the power saving mode is active only a lowest power preset is selectable, and or when the lowest power preset is selected this is also treated as selection of power saving mode.

Thus the power saving mode may constrain the possible power settings to a subset of the heater settings that may be available in a normal mode.

As mentioned above, the power saving mode may control one or more additional or alternative power consuming elements different to the heater power. These may include heater activation duration (puff duration), output element power and/or controller/processor power. Thus where the selection of low power mode can be provided by input options additional to or instead of a low power mode selection input option, further or alternative input options corresponding to these other power consuming elements of the non-combustible aerosol provision system can also be provided.

Where the existing power consumption state of the device 10 was communicated at S31, the user may be restricted to selecting an available heater power setting for the existing power consumption state. The available heater power setting or settings may be selected based on the objective of the power consumption state. For example, for a power saving mode, the available heater power settings may be restricted to relatively lower heater power settings than would otherwise be available when not operating in the power saving mode.

As shown in FIG. 3, at S35, the user device 40 is configured to transmit an instruction to adopt the low power mode to the non-combustible aerosol provision system 10. This transmission is carried out by the receiver transmitter element 42 of the user device 40 to be received by transmitter/receiver element 26 of the non-combustible aerosol provision system 10. In this example, the transmission occurs via BLE, however, it will be appreciated that any suitable communication technology such as those mentioned above may be used.

In this example, to transmit the instruction to adopt the low power mode, the user device 40 is configured to write a value representative of the specific power consumption limit(s) that are to be applied the relevant non-combustible aerosol provision system components in accordance with a Bluetooth profile specification governing the BLE communication between the user device 40 and the non-combustible aerosol provision system 10. Thus the non-combustible aerosol provision system 10 does not need to interpret an instruction or chose any values for the power saving mode. Rather the specific values to be used are directly provided to the non-combustible aerosol provision system 10 for use until changed by a later instruction (for example user decision to remove power saving mode, a charging event or a reset event).

Specifically, in the example of the power saving mode including controlling the heater power, the user device 40 is arranged to write a value in the form of an unsigned integer to the non-combustible aerosol provision system 10. The unsigned integer may take values with a certain range corresponding to lower and upper limit values of the heater power supported by the device 10. To determine the power to be applied to the heater from the value written to the device 10, the device 10 divides the value by ten. Therefore, to transmit an indication that the heater power should be set to 2.0 W, the user device 40 writes a value of 20 to the device 10 over the BLE interface. Thus, the specific heater power required in power saving mode is written directly using this approach.

In examples in which the power saving mode includes controlling the power of other power-consuming components or elements of the non-combustible aerosol provision system 10, a similar approach may be used to write a power saving mode puff duration value, a power saving mode output element power level and/or a processor/controller power level/mode value to the non-combustible aerosol provision system 10.

It will be appreciated that these examples provides just one illustrative example of how the required power saving mode power settings may be transmitted to the user device and other modes of communication and encoding schemes for the heater power setting may be employed.

In another example, rather than writing specific power saving mode control values to the non-combustible aerosol provision system 10, the user device 40 may instead send a less specific instruction to activate power saving mode to the non-combustible aerosol provision system 10. In such an approach the non-combustible aerosol provision system 10 then interprets this instruction to adopt power saving mode according to local parameters. This may include the non-combustible aerosol provision system 10 having already stored power values for the power consumption variables of the relevant power-consuming components of the non-combustible aerosol provision system 10. In the alternative, the non-combustible aerosol provision system 10 may include power saving mode programming to enable the processor/controller 22 to determine which power consuming element(s) needs a specific power control setting and to establish an appropriate value for that setting.

Once the power saving mode power setting values are set at the non-combustible aerosol provision system 10, the non-combustible aerosol provision system then operates according to the indicated power settings. Thus in the case of heater power settings, the non-combustible aerosol provision system 10 permits power to be supplied from the power source (such as the battery 18 or an exothermic power source) to the heater (e.g., heater coil 20). By adjusting the power provided to the heater in this way, the temperature to which the aerosolizable material is heated can be adjusted, thereby adjusting the properties of the aerosols produced by the non-combustible aerosol provision system 10. In this way, the cloud size/intensity of the aerosols produced by the device can be controlled to maximize the life of the power source and/or aerosolizable material resource.

In the examples of other power-consuming components also or alternatively being controlled to low power operation in the power saving mode, the non-combustible aerosol provision system 10 likewise uses the indicated settings as written to the non-combustible aerosol provision system 10 at S35 to control the power available to such elements. For example a low power setting for the output element may limit the brightness to which an LED indicator light is lit to a low power option, or may also prevent the LED indicator light from being activated at all.

In contrast to an approach in which the user specifies a target temperature for the heater, by controlling the power supplied to the heater, the manufacture of the device 10 and control of the heater can be simplified. Since the power supplied by a power source (e.g., battery 18) can be controlled using power supply circuitry that is relatively easy to manufacture and control, the process of manufacturing the non-combustible aerosol provision system 10 and controlling the heater power setting can be made more efficient than an approach attempting to control a temperature of the heater. Such a temperature-based approach would likely require a temperature sensing element (such as a thermistor) and feedback control, and/or very careful calibration.

An example of a user interface screen that may be provided to a user by the output device 50 of the user device 40 to invite and/or receive such input is shown in FIG. 4.

As shown, the user interface screen 60 comprises a number of power mode indicators 62 which can be selected to adopt a specific power mode (which in turn may correspond to a power consumption state). In the present example, the indicator 62a for Mode 1 corresponds to a normal mode in which all power levels are available and the indicator 62b for Mode 2 corresponds to a power saving mode that can be engaged as discussed above. Thus, in the present example, the power saving mode is activated by selection of Mode 2 via indicator 62b.

The user interface screen 60 also comprises a number of present indicators 64 which can be selected to adopt a specific power level preset. In the present example, the indicator 64a for Preset A corresponds to a low power level, the indicator 64b for Preset B corresponds to a medium power level, and the indicator 64c for Preset C corresponds to a high power level. In the present example, when Mode 1 (normal mode) has been selected, all of these preset modes are available for selection, but when Mode 2 (low power mode) is selected, only the low power Preset A, or the low power Preset A and the medium power Preset B are available for selection.

The user interface screen 60 also comprises a power selection slider 66, which includes a power selection control element 68 which may be selected for moving along the slider 66 to vary the power. In the present example, when Mode 1 (normal mode) has been selected, the full range of the slider 66 is available for selection using the poser selection control element 68, whereas when Mode 2 (low power mode) is selected, only the lowest power setting or a restricted range toward the low power end of the range is available for selection using the poser selection control element 68.

In other examples, an alternative user interface approach may be used. A greater or smaller range of indicators and/or selectors may be provided, and/or the user interface elements may be split across multiple user interface screens. In some examples, there may be presented either preset indicators or a slider but not both. In some examples, there may be only the option to choose between normal (standard) and power saving modes and thus no options for presets or a power slider.

Hence, there has been described an efficient and effective approach to controlling a non-combustible aerosol provision system 10 into a power saving mode by a user of a user device 40 that is coupled to the non-combustible aerosol provision system 10, thereby allowing the user to effectively extend the life of a power source and/or aerosolizable material reserve of the non-combustible aerosol provision system 10.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A non-combustible aerosol provision system comprising:
an aerosol generator to generate aerosols;
a power source to supply power to the aerosol generator; and
a transmitter/receiver element configured to communicably couple the non-combustible aerosol provision system to a user device;
wherein the non-combustible aerosol provision system is operable in a standard mode and a power-saving mode, wherein when the non-combustible aerosol provision system is in the power-saving mode, the power source is configured to supply less power to one or more power-consuming components of the non-combustible aerosol provision system than when the non-combustible aerosol provision system is in the standard mode; and
wherein the transmitter/receiver element is configured to receive an instruction from the user device, the instruction configured to cause the non-combustible aerosol provision system to enter the low power mode.

2. The non-combustible aerosol provision system of claim 1, wherein the instruction comprises one or more instructions to operate according to low power mode instructions previously stored by the non-combustible aerosol provision system.

3. The non-combustible aerosol provision system of claim 1, wherein the instruction comprises one or more instructions that write a specific power range for the one or more power-consuming components to the non-combustible aerosol provision system.

4. The non-combustible aerosol provision system of claim 3, wherein the specific power range is a specific power value.

5. The non-combustible aerosol provision system of claim 1, wherein the one or more power-consuming components of the non-combustible aerosol provision system comprise the aerosol generator.

6. The non-combustible aerosol provision system of claim 5, wherein the aerosol generator comprises a heater and the power source is configured to supply less power to the aerosol generator by reducing a power supply voltage to the heater.

7. The non-combustible aerosol provision system of claim 5, wherein the power source is configured to supply, when in the power saving mode, a minimum operational power to the aerosol generator.

8. The non-combustible aerosol provision system of claim 5, wherein the power source is configured to supply to the aerosol generator, when in the power saving mode, a power within a contiguous subset of an overall operational power settings range of the aerosol generator, the subset including a minimum operational power setting.

9. The non-combustible aerosol provision system of claim 1, wherein the one or more power-consuming components include one or more indicator lights of the non-combustible aerosol provision system.

10. The non-combustible aerosol provision system of claim 9, wherein the power source is configured to supply, when in the low power mode, a low operational power level to the one or more indicator lights.

11. The non-combustible aerosol provision system of claim 1, wherein the one or more power-consuming components include a processor of the non-combustible aerosol provision system.

12. A user device configured to be communicably coupled to a non-combustible aerosol provision system, the user device comprising:
an output device configured to provide user interface information to a user;
an input device configured to receive an input from the user to activate a power saving mode of a communicably coupled non-combustible aerosol provision system; and
a receiver transmitter element configured to send an instruction to adopt the power saving mode to the communicably coupled non-combustible aerosol provision system, the instruction to cause a power source of the non-combustible aerosol provision system to supply less power to one or more power-consuming components of the non-combustible aerosol provision system than when the non-combustible aerosol provision system is in a standard mode.

13. The user device of claim 12, wherein at least one of the following:
the instruction is configured to cause the communicably coupled non-combustible aerosol provision system to adopt power saving mode settings already stored at the non-combustible aerosol provision system;
the instruction writes a specific power range for the one or more power-consuming components to the non-combustible aerosol provision system;
the specific power range is a specific power value;
the instruction comprises an instruction to supply a low power level from the power source to an aerosol generator of the non-combustible aerosol provision system;
the instruction comprises an instruction to supply a low power level from the power source to a heater of the aerosol generator;
the instruction comprises an instruction to supply a minimum operational power to the aerosol generator;
the instruction comprises an instruction to supply to the aerosol generator, a power within a contiguous subset of an overall operational power settings range of the aerosol generator, the subset including a minimum operational power setting;
the instruction comprises an instruction to supply a low power level from the power source to one or more indicator lights of the non-combustible aerosol provision system;
the instruction comprises an instruction to supply a low operational power level to the one or more indicator lights; or
the instruction comprises an instruction to supply a low power level from the power source to a processor of the non-combustible aerosol provision system.

14-22. (canceled)

23. A system comprising:
a non-combustible aerosol provision system; and
a user device communicably coupled to the non-combustible aerosol provision system;
wherein the non-combustible aerosol provision system is operable in a standard mode and a power-saving mode, wherein when the non-combustible aerosol provision system is in the power-saving mode, a power source is configured to supply less power to one or more power-consuming components of the non-combustible aerosol provision system than when the non-combustible aerosol provision system is in the standard mode; and
wherein the user device is configured to send an instruction to adopt the power saving mode to the non-combustible aerosol provision system.

24. The system of claim 23, wherein at least one of:
the instruction comprises one or more instructions to operate according to low power mode instructions previously stored by the non-combustible aerosol provision system;
the instruction comprises one or more instructions that write a specific power range for the one or more power-consuming components to the non-combustible aerosol provision system;
the specific power range is a specific power value;
the one or more power-consuming components of the non-combustible aerosol provision system comprise the aerosol generator;
the aerosol generator comprises a heater and the power source is configured to supply less power to the aerosol generator by reducing a power supply voltage to the heater;
the power source is configured to supply, when in the power saving mode, a minimum operational power to the aerosol generator;
the power source is configured to supply to the aerosol generator, when in the power saving mode, a power within a contiguous subset of an overall operational power settings range of the aerosol generator, the subset including a minimum operational power setting;
the one or more power-consuming components include one or more indicator lights of the non-combustible aerosol provision system;
the power source is configured to supply, when in the low power mode, a low operational power level to the one or more indicator lights; or
the one or more power-consuming components include a processor of the non-combustible aerosol provision system.

25-33. (canceled)

34. A non-transitory computer-readable storage medium comprising instructions which, when executed by processing circuitry of a computing device configured to be communicably coupled to a non-combustible aerosol provision system, cause the computing device to:
receive an input from a user to activate a power saving mode of a communicably coupled non-combustible aerosol provision system; and
send an instruction to adopt the power saving mode to the communicably coupled non-combustible aerosol provision system, the instruction to cause a power source of the non-combustible aerosol provision system to supply less power to one or more power-consuming components of the non-combustible aerosol provision system than when the non-combustible aerosol provision system is in a standard mode.

35. A non-transitory computer-readable storage medium of claim 34, wherein at least one of:
the instruction is configured to cause the communicably coupled non-combustible aerosol provision system to adopt power saving mode settings already stored at the non-combustible aerosol provision system;
the instruction writes a specific power range for the one or more power-consuming components to the non-combustible aerosol provision system;
the specific power range is a specific power value;
the instruction comprises an instruction to supply a low power level from the power source to an aerosol generator of the non-combustible aerosol provision system;
the instruction comprises an instruction to supply a low power level from the power source to a heater of the aerosol generator;
the instruction comprises an instruction to supply a minimum operational power to the aerosol generator;
the instruction comprises an instruction to supply to the aerosol generator, a power within a contiguous subset of an overall operational power settings range of the aerosol generator, the subset including a minimum operational power setting;
the instruction comprises an instruction to supply a low power level from the power source to one or more indicator lights of the non-combustible aerosol provision system;
the instruction comprises an instruction to supply a low operational power level to the one or more indicator lights; or
the instruction comprises an instruction to supply a low power level from the power source to a processor of the non-combustible aerosol provision system.

36-44. (canceled)
